(19) United States
(12) Patent Application Publication
(10) Pub. No.: US 2002/0005864 A1
(43) Pub. Date: Jan. 17, 2002

(54) Haptic virtual environments

(75) Inventors: Bharti Temkin, Ransom Canyon, TX (US); Eric Acosta, Lubbock, TX (US)

Correspondence Address: PERKINS, SMITH & COHEN LLP, ONE BEACON STREET, 30TH FLOOR, BOSTON, MA, 02108, US

(73) Assignee: Texas Tech University

(21) Appl. No.: 09/844,635

(22) Filed: Apr. 28, 2001

Related U.S. Application Data
(60) Provisional application No. 60/200,407, filed on Apr. 28, 2000.

(51) Int. Cl. G06F 3/00

(52) U.S. Cl. 345/701

(57) ABSTRACT

Existing virtual environments for surgical training and preparation and other purposes can be improved beyond visual aspect by incorporation of haptics into virtual reality situations to enhance the sense of realism greatly. The invention, a graphics to haptic, G2H, virtual environment developer tool, which transforms graphical virtual environments (created or imported) to haptic virtual environments without programming.

### FIELD AND BACKGROUND OF THE INVENTION

The present invention relates to systems, processes, apparatus and software cooperatively providing virtual environments, particularly with displayed 3D polymesh models and/or haptic or touching virtual environments and/or combinations thereof.

Haptic Environments

Haptic environments are known wherein a displayed object can be “touched” using a haptic device. More particularly, the object can be manipulated via configurable view-ports that allows the object being touched to be modified such that a user can create a wide variety of objects with a wide variety of characteristics, for example stiffness and friction, without having to resort to generating code.

In computer generated virtual environments the interfacing and integration of physically felt force-feedback devices (haptic interface devices) that provide the touch or feel sensation are labor intensive typically requiring expert personnel. Those that exist use expensive complex and often ad hoc hardware and software that are difficult to implement and more difficult to service and/or modify. High end, expensive graphic workstations, e.g. Sun Microsystems, with specialized hardware and/or software have been so used, but are not amendable to routine use due to the complexity and the expense. These conditions have limited the application of haptics.

Haptics refers to touch. Human sense of touch, human haptics, differs fundamentally from other human sensory modalities in that it is bilateral in nature: to touch an object, the object must “push” back. In computer generated haptics, a computer interface device is used that provides a physical touch to the human that corresponds to the real three-dimensional sense of touch that allows one to feel textures and shapes of objects, modulate objects and even deform objects.

Two major components of computer haptics are collision detection of virtual objects with the haptic interface device, and the determination and application of a force feedback to the user via the haptic interface device. Prior art data structures and algorithms applied to haptic rendering have been adopted from non-pliable surface-based graphic systems. These prior art techniques and systems are inappropriate and limited due to the different characteristics required for haptic rendering of polymesh models.

Such prior art technology is even more limited when applied to teaching the complex skills associated with critical technical fields, like medical surgery. Surgery skills are taught on live patients or animals. A haptic computer system that provides a high level means for a user to develop, use, and modify objects that have a compelling sense of tactile “realness” is needed.

It is an object of the present invention to generate a haptic application interface suitable for providing a haptic virtual environment especially for fields, such as surgical simulation, wherein the user can manipulate objects at a high level without needing to generate directly any code.

It is another object of the present invention to produce the illusion of being able to “touch and feel” in a haptic 3D virtual environment, for example, and to be able to modify such objects with true-to-life point-based touch sensation.

It is still another object of the present invention to provide complex and precise haptic virtual objects thereby allowing object developers to create and modify objects directly—i.e. making displays haptic without writing code.

### SUMMARY OF THE INVENTION

The objects set forth above as well as further and other objects and advantages of the present invention are achieved by the embodiments of the invention described herein below.

The present invention meets the foregoing objects with a system (process, apparatus) that generates one or more of: (a) transformations from physical models or data file representations thereof to graphical virtual objects and (b) transformations from graphical objects to haptic virtual objects and modification via a graphic-to-haptic (G2H) interface enabling such transformation and modification without writing code. (reduced./jc)

The present invention utilizes more particularly a graphics software package, an animation software package and a software plug-in for a computer systems that can be applied to any virtual object. The virtual objects in a preferred embodiment can be created or imported into the system where the object can be modified. The system is operated with a haptic device that provides the actual force feedback to the user. In a preferred embodiment that device may be a phantom brand commercially available stylus.

The contents of the following references are incorporated herein by reference as though set out at length.

a) Eric Acosta, Bryan Stephens, Bharti Temkin, Ph.D., Thomas M. Krummel, MD, John A. Griswold MD, Sammy A. Deeb MD, “Development of a Haptic Virtual Environment”, Proc. 12^{th} Symp.IEEE/Computer-Based Medical Systems CBMS—1999.

b) Eric Acosta, B. Temkin, T. Krummel, W. L. Heinrichs, “G₂H—Graphics-to-Haptic Virtual Environment Development Tool for PC's”, Medicine Meets Virtual Reality, Envisioning Healing, J. D. Westwood, H. M. Hoffman, G. Mogel, D. Stredney, (Eds), MMVR2000.

c) K. Watson, B. Temkin and W. L. Heinrichs, “Development of Haptic Stereoscopic Virtual Environments”, Proc. 12^{th} Symp.IEEE/Computer-Based Medical Systems CBMS.

d) Bryan Stephens, Bharti Temkin, Wm. LeRoy Heinrichs, MD, Ph.D., Thomas M. Krummel, MD, “Virtual Body Structures: A 3D Structure Development Tool from Visible Human Data”, Medicine Meets Virtual Reality, Envisioning Healing, J. D. Westwood, H. M. Hoffman, G. Mogel, D. Stredney, (Eds), MMVR2000.

e) Fung Y C. Biomechanics, mechanical properties of living tissues, 2^{nd} Ed, Springer-Verlag, New York, 1993.

f) Ottensmeyer, Mark P., Ben-Ur, Ela, Salisbury, Dr. J. Kenneth. “Input and Output for Surgical Simulation: Devices to Measure Tissue Properties in vivo and a Haptic Interface for Laparoscopy Simulators.” Proceedings of Medicine Meets Virtual Reality 2000, Newport Beach, Calif. IOS Press. 236-242. Jan. 27-30, 2000.

g) Maab H, Kuhnapfel U. Noninvasive Measurement of Elastic Properties of Living Tissue, CARS '99: Computer Assisted Radiology and Surgery: proceedings of the 13^{th} international congress and exhibition, 865-870, Paris, Jun. 23-26, 1999.

h) Scilingo EP, DeRossi D, Bicchi A, Iacconi P. Haptic display for replication of rheological behavior of surgical tissues: modelling, control, and experiements, Proceedings of the ASME Dynamics, Systems and Control Division, 173-176, Dallas, Tex., Nov. 16-21, 1997.

i)Jon Burgin, Bryan Stephens, Farida Vahora, Bharti Temkin, William Marcy, Paul Gorman, Thomas Krummel, “Haptic Rendering of Volumetric Soft-Bodies Objects”, The third PHANToM User Workshop (PUG 98), Oct 3-6, MIT Endicott House, Dedham, Mass.

For a better understanding of the present invention, together with other and further objects thereof, reference is made to the accompanying drawings and detailed description.

### BRIEF DESCRIPTION OF THE DRAWING

The Drawing comprises the following figures:

FIG. 1 (breast) and FIG. 1A (pelvic region) are composite expanded views of the physical plug-in interface utilized according to a first preferred embodiment of haptic environment generation pursuant to the present invention;

FIG. 2 is a graphical representation of the object digitizing process utilized in that embodiment;

FIG. 3 is a graphical representation of a poly-mesh form of a created object in such environment;

FIG. 4 is a graphical representation of a multi-layer volumetric object; and

FIG. 5 is a graphical representation of a virtual human breast object including a tumor with haptic response capability for a computer display user to examine as a doctor would.

### DETAILED DESCRIPTION OF PREFERRED EMBODIMENTS

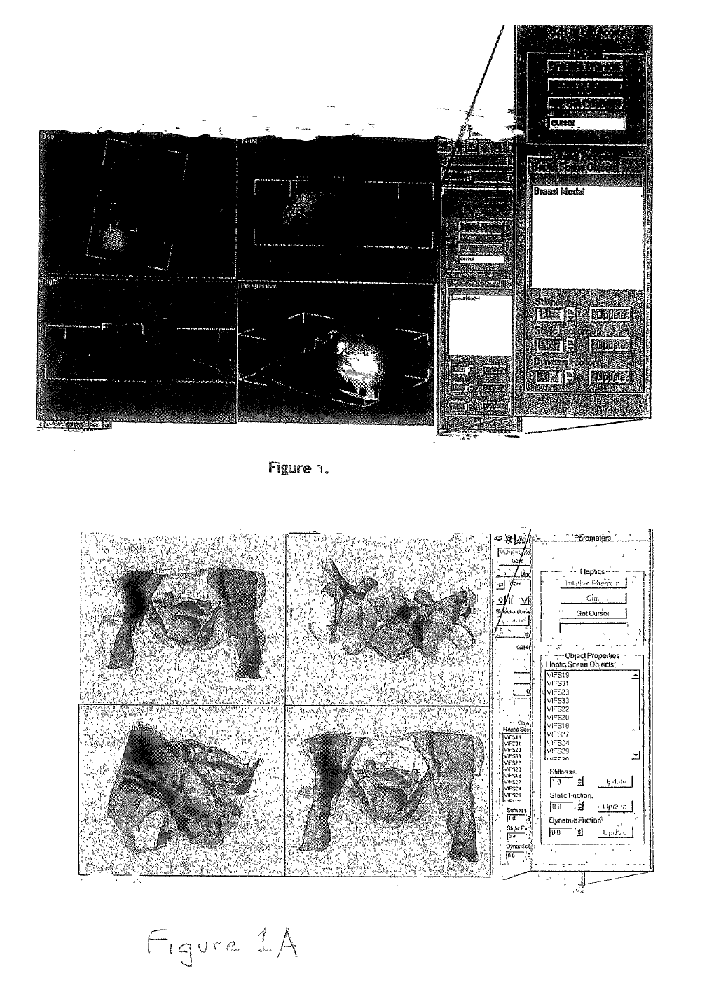

FIGS. 1 and 1A shows the system and the interface modifier used for manipulating and completing objects that were created or imported into the system in a preferred embodiment. Such a system can utilize (for example and not by way of limitation thereto) commercially available high resolution digitizing systems that is interfaced to the software and hardware as described just above. The physical system includes PC's running 300 MHz Pentium II® running Windows NT® 4.0, service pack 3. This preferred embodiment system has 128 MB of RAM and an OpenGL® accelerator video card of 8 MB. The high resolution digitizing system of FIG. 1 has a fifty inch spherical workspace with a mean accuracy of 0.015 inches (0.38 mm). The models are saved in industry standard formats and may be seamlessly interfaced with the 3D graphics and animation software package. The system operator by specifying Cartesian coordinates (x, y, z), roll, pitch, and yaw orientations controls the system cursor, point of view, light sources and any 3D positioning tasks.

Known tools of graphic and haptic response can be incorporated including, illustratively and not by way of limitation, the Microscribe—3D system described, e.g., on the proprietor's web site at www.immerse.com; 3DStudio MAX at www.ktx.com/3dsmaxr2; and Sensable Company's Ghost brand software developer tool kit at www.sensable.com.

An advantage of this aspect of the present invention is that the system user can develop complex and precise haptic virtual objects without having to generate software code. Omitted from FIGS. 1 and 1A are the command lines of the standard 3D Studio Max product (which per se is not part of the present invention). The expanded table on the right lists Parameters, Haptics, Initialize Phantom, Quit, Get cursor, Object Properties, the latter including Haptic Scene objects (a list of selected or selectable objects), Stiffness, Static Friction, Dynamic Friction and an Update button associated with each of these properties.

The user creates a cursor and selects an object. The user places the cursor name in the text dialog box and activates a “get cursor” command button. The object selected appears in the “Object Properties List Box” where the user can select and modify each object by providing means for creating a volumetric 3D object with internal layers. The user can modify the surface stiffness and/or add static and dynamic surface friction to any of the layers. In this way a volumetric object is created which provides for a realistic touch so that when the user activates the haptic device button, the user can “feel” the object.

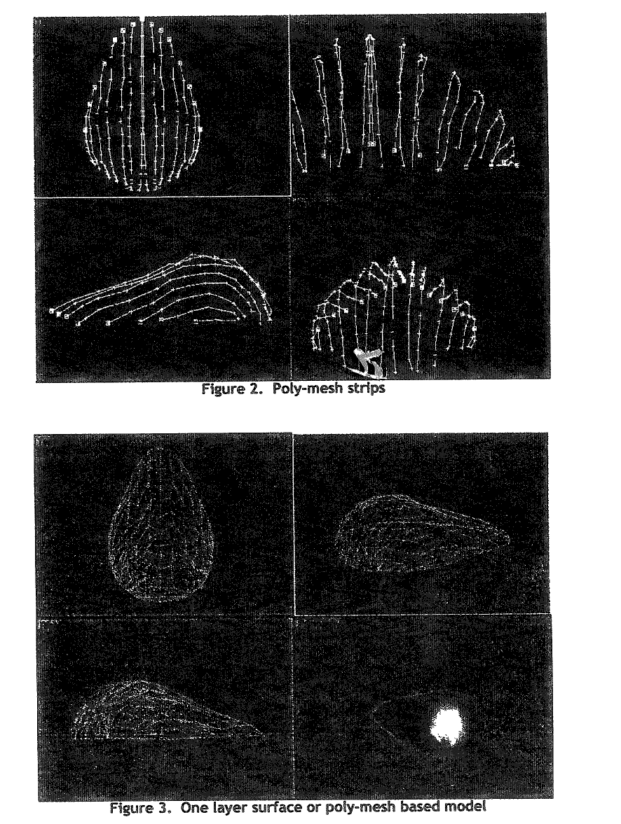

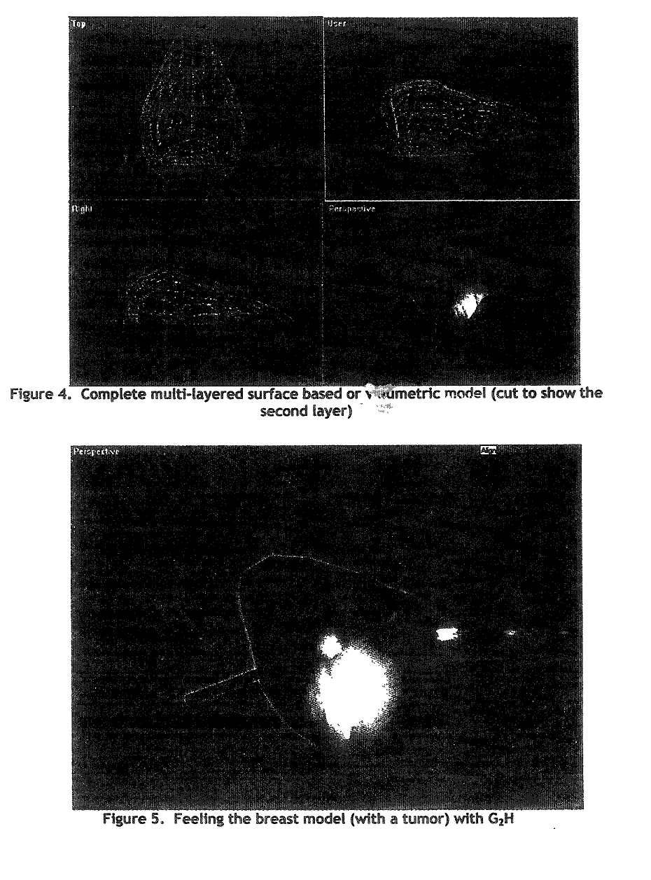

The location of the physical model of an object being created or imported is a series of points that the computing system maintains fixed relative to each other. FIG. 2 shows the process of connecting these points, and the 3D graphics connects the “lines” forming “poly-mesh” strips that are the surface of the virtual model. At this point the user can adjust the model's surface to compensate for irregularities. The virtual object is now converted to a poly-mesh or surface form as shown in FIG. 3. The user can copy the object or scale the object up or down to produce other surfaces. The user can insert the smaller objects into the larger objects to form a multi-layer object or volumetric model as shown in FIG. 4.

At this point the user can manipulate the various layers within the volumetric object and ascribe stiffness, static and dynamic friction, texture, and the like to those surfaces so that touching the virtual object via a haptic device actually produces a feeling substantially identical to touching a real object. The user can then create and modify a multitude of objects by such methods without having to write and debug any code.

Once an object has been created, modified it can be touched using a haptic device as described above. The interface/graphics package provides a number of configurable view ports that operate with the haptic device. The interface/computer/graphics allow rotation, translation, scaling, bending, twisting, tapering, and volumetric resolution changes within a scene. Moreover, these abilities are interactive and dynamic. This provides the advantage that the user can manipulate the objects and their dynamic characteristics and parameters in virtually any fashion desired. This allows the user to operate at a high level and not be concerned with coding.

Haptic textures can be created with G₂H and saved for later use. Each texture has unique stiffness, damping, and static and dynamic friction components needed to represent different body structures haptically. The stiffness component is used to control the hardness of an object. The addition of damping causes the force to feel less crisp. Static friction is used to reflect the sense of constant frictional force as the user glides over the surface. Dynamic friction is an additional force that increases or decreases with velocity changes, as the user glides over the surface. A haptic texture is a combination of these parameters.

Development of methods, tools, and devices for measuring properties of living tissues, generating mathematical models, as well as simulations of these properties for interactive virtual reality applications, have become major research topics for many institutions. As the additional parameters, that improve the quality of haptic texture, become available, they can be easily incorporated into G₂H. The haptic texture can be applied to the scene objects interactively and it can be modified dynamically. When the texture properties of a selected object are modified and applied, the object immediately feels different. The haptic texture can be also saved into a database for the later use. This system allows the entire scene, including the object-texture associations, to be saved so that they may be viewed and touched at a later time.

Although the invention has been described with respect to various embodiments, it should be realized this invention is also capable of a wide variety of further and other embodiments within the spirit and scope of the invention.

1. Computer interface system comprising:
(a) means for providing a cursor for linkage with objects;
(b) means for generating the haptic representation of objects directly from the graphical representation of the objects for linkage with the cursor;
(c) means for creating, modifying, and saving haptic materials for creating a heuristic database to be used in the modeling of haptic virtual environments; and
(d) means for utilizing the material database for the modeling of haptic virtual environments.

2. The system of claim 1 wherein said data base comprises one or more of static friction, dynamic friction, stiffness, and damping components
